(19) United States
(12) Patent Application Publication
(10) Pub. No.: US 2005/0263999 A1
(43) Pub. Date: Dec. 1, 2005

(54) Personalized commemorative event card display

(76) Inventors: Marcia English, Fairway, KS (US); Mary Lynn Iskak, Merriam, KS (US)

Correspondence Address: FISH & RICHARDSON P.C., PO BOX 1022, MINNEAPOLIS, MN, 55440-1022, US

(21) Appl. No.: 10/858,486

(22) Filed: Jun. 1, 2004

(51) Int. Cl. B42F 5/00

(52) U.S. Cl. 281/22

(57) ABSTRACT

An apparatus for displaying personalized commemorative cards may include multiple pages, a binding to bind those pages together, and a series of cards containing personalized commemorative sentiments to display on the pages. In one embodiment, the cards are presented at an event and guests are invited to write on the cards personalized messages to one or more celebrated persons. The cards may be collected after the event and optionally installed into a display album that is adapted to hold the personalized cards so that at least a substantial portion of the personalized messages are exposed such that the various messages can be readily viewed as the album pages are turned.

### TECHNICAL FIELD

This document relates to the display of personalized objects and in preferred embodiments to the display of personalized commemorative event cards.

### BACKGROUND

There are few events in a person's life for which large numbers of the person's friends and family gather together in celebration. Weddings, bridal showers, graduations, baby showers, baptisms, first communions, confirmations, and bar mitzvah's are among these events. Due to the nature of the events, and to their infrequency, such events generally evoke strong emotions in the celebrated person. The celebrated person often desires to capture the memories of such an event to preserve them for life-long enjoyment.

One way to commemorate such an event is through photographs. Photographs of the celebrated person interacting with loved ones, of special guests, and of other various memorable items have, for many years, allowed people to commemorate special events. The photographs can be arranged and displayed according to the celebrated person's preferences. One common way to display commemorative photographs is to put them in frames. A way to display a larger number of photographs is to arrange them in a photo album. Using either approach, the celebrated person is able to look at the displayed photographs and recall the special event.

The celebrated person often desires some form of written commemoration of the special event. The celebrated person may log his or her perceptions of, and reflections on, a special event in a journal. Greeting cards may provide a way for the celebrated person to capture the sentiments of guests.

According to one embodiment of the invention, another way of capturing the memories of a special event in writing is to allow guests of the special event to write personalized commemorative sentiments on cards. The personalized commemorative sentiments may include words of advice or inspiration, special stories shared by the guest and the celebrated person, or other special thoughts the guest chooses to share with the celebrated person. The celebrated person may collect the cards and enjoy them for many years. The celebrated person may wish to maintain the cards in a safe place and to display them in an easily-accessible format. The personalized commemorative cards provide the celebrated person with special memories of the event from several different vantage points, leading to a richer account for future enjoyment.

### SUMMARY

An apparatus for displaying personalized commemorative cards may include multiple pages, a binding to bind those pages together, and a series of cards containing personalized commemorative sentiments to display on the pages. In one embodiment, the cards are presented at an event and guests are invited to write on the cards personalized messages to one or more celebrated persons. The cards may be collected after the event and optionally installed into a display album that is adapted to hold the personalized cards so that at least a substantial portion of the personalized messages are exposed such that the various messages can be readily viewed as the album pages are turned. In certain embodiments the cards with personalized messages are mounted on the same page and adjacent to photographs related to the same celebrated occasion.

A kit for commemorating an event may include an album with pages for displaying personalized cards, multiple cards that can be provided to guests, allowing the guests to personalize the cards, and a writing utensil. The kit may also include various mechanisms for fastening the cards to the pages.

Certain embodiments may provide one or more of the following advantages. Some embodiments may provide a means to display personalized cards such that they may be readily viewed without manipulation of any envelope or other obstruction. Other embodiments may preserve the personalized cards, protecting them from abrasion. Other embodiments may allow for display of personalized cards alongside photographs.

The details of one or more embodiments are set forth in the accompanying drawings and the description below. Other features, objects, and advantages will be apparent from the description and drawings, and from the claims.

### DESCRIPTION OF FIGURES

FIG. 1 is a perspective view of a commemorative album.

FIG. 2 is a top view of the commemorative album shown in FIG. 1.

FIG. 3 is a top view of a closed commemorative album.

FIG. 4 is a perspective view of a kit for commemorating an event.

FIGS. 5A-5C are perspective views of three different types of mechanisms for holding and displaying cards.

FIG. 6A is a perspective view of a commemorative album having an alternative binding configuration than that of FIGS. 1-2.

FIG. 6B is a top view of the commemorative album shown in FIG. 6A.

FIGS. 7A-7B are flow charts illustrating a method of using a wedding guest commemoration kit to commemorate a wedding.

Like reference symbols in the various figures indicate like elements.

### DETAILED DESCRIPTION OF ILLUSTRATIVE EMBODIMENTS

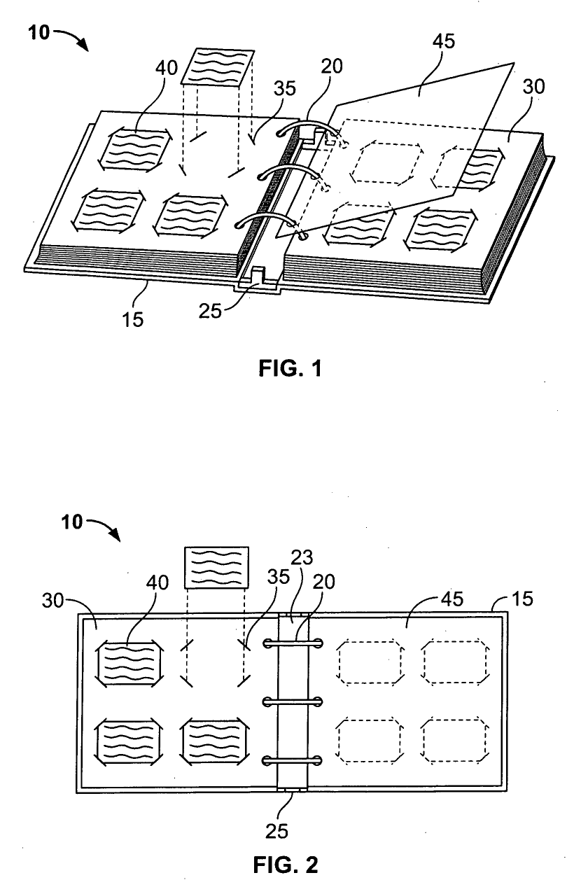

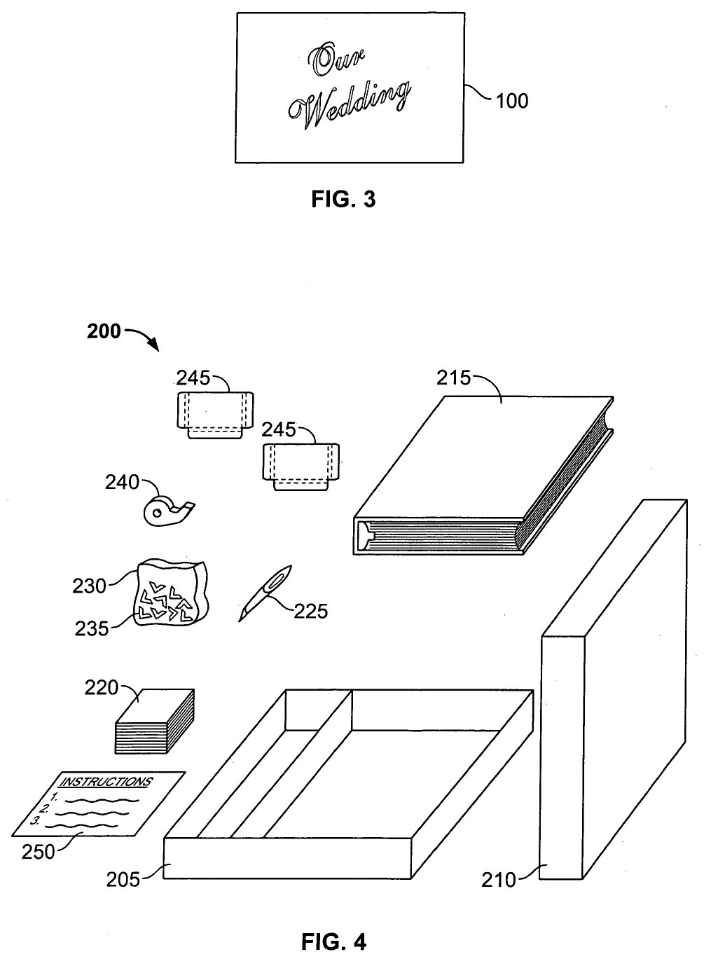

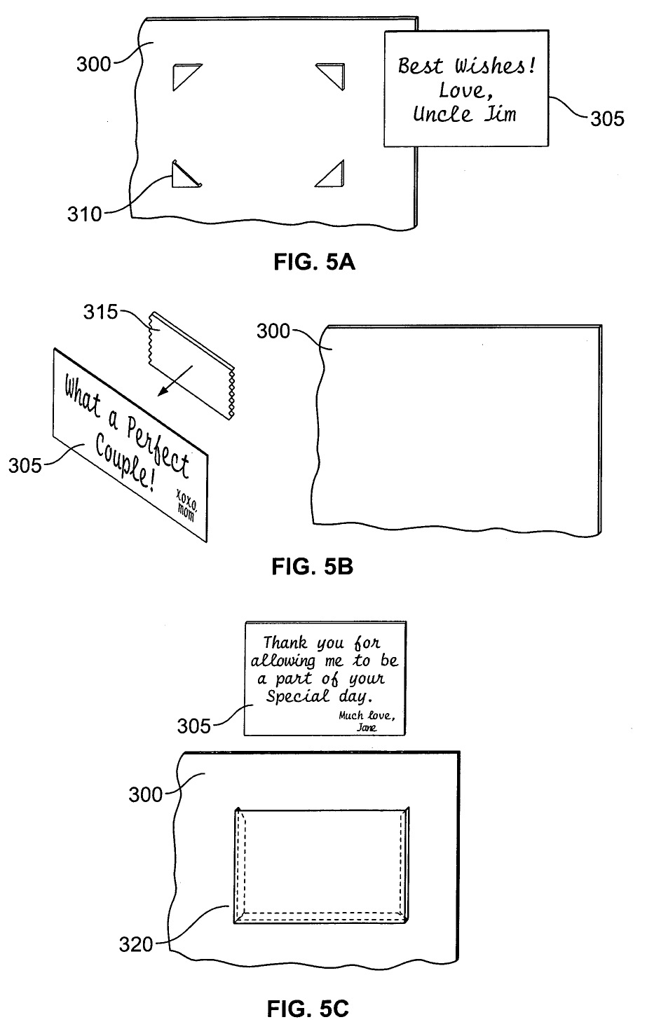

FIGS. 1-2 show a commemorative album 10. The commemorative album 10 has a cover 15. The cover 15 may serve as an outer shell for the commemorative album 10. The cover 15 may also be decorated according to an event being commemorated in the commemorative album 10 or in any other decorative fashion. The cover 15 is described in more detail in connection with FIG. 3.

The commemorative album 10 includes pages 30 that may hold and display various items that are associated with an event being commemorated in the commemorative album 10. The pages 30 may be made out of paper, cardstock, polymer, wood, metal, or other appropriate material, or combinations thereof. The pages 30 may also be substantially covered by polymer, fabric, or other material designed to provide a decorative look to the pages 30. Some page 30 configurations may involve multiple layers. For instance, a piece of paper or cardstock may be folded in half to provide a page 30. Another example of a multi-layered page 30 involves two pieces of paper or cardstock being fastened together by an adhesive.

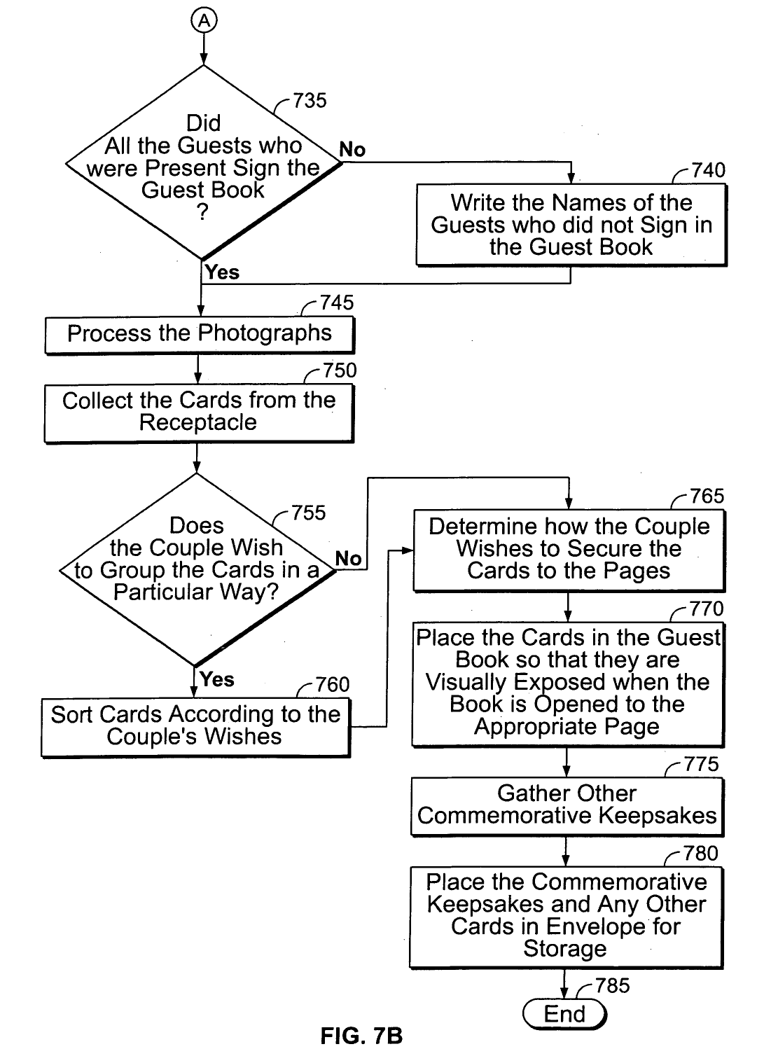

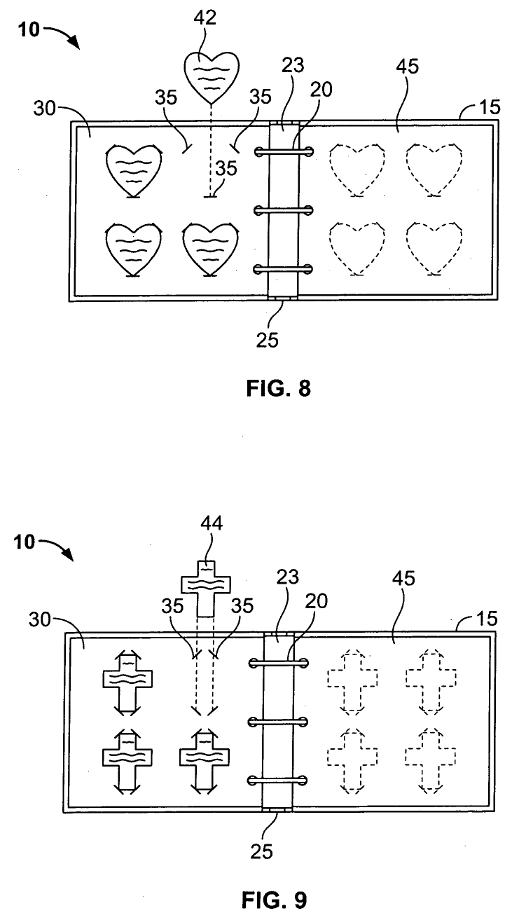

The pages 30 are bound together by binder rings 20. The binder rings 20 are held in place by a plate 23, which is fastened to the cover. Three binder rings 20 are shown, but any appropriate number of binder rings 20 may be used. The binder rings 20 may be made of metal, polymer, or other rigid material. Each binder ring 20 may comprise multiple pieces, allowing the binder rings 20 to open. When the binder rings 20 are open, a user may add or remove one or more pages 30. The user may open the binder rings 20 by pressing outward on one or both handles 25. Alternatively, handles 25 need not be provided. Instead, users may open the binder rings 20 by pulling the two half sections of the binder rings 20 apart and may close the binder rings 20 by pressing the two sections of the binder rings 20 together. Different binder configurations are discussed in conjunction with FIGS. 6A-6B.

Each page 30 contains several slits 35. The slits 35 are positioned in groups of four so that each slit 35 is able to receive one corner of a card 40 that is rectangular in shape. The slits 35 are each angled such that the inserted portion of the card 40 forms substantially a right isosceles triangle. A user may insert the card 40 by inserting two corners into two slits 35, bending the card 40 slightly, and inserting the other two corners into the opposing slits 35. Four cards per page are shown, but the pages 30 may be configured to hold any appropriate number of cards depending on the size of the cards, the desired spacing between the cards, and other such factors. Also, cards 40 are shown as being displayed on both sides of a page 30, but it is possible to display cards 40 on only one side of the page 30.

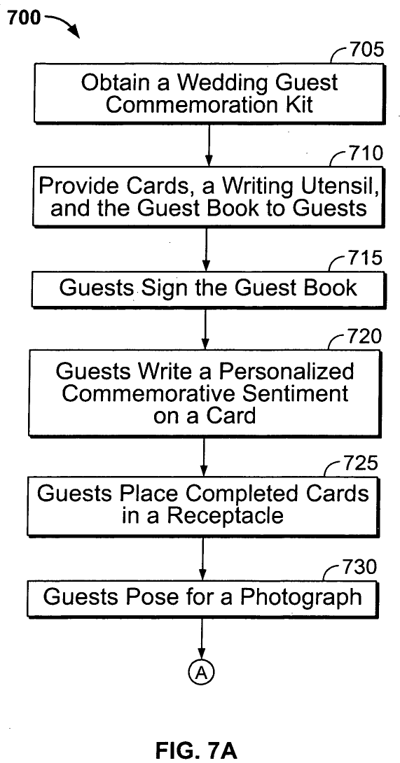

Many slit configurations exist that enable reception and display of cards 40 having a rectangular shape. For instance, two slits 35 may be omitted, leaving only the bottom two slits 35, the top two slits 35, two of the side slits 35, or slits 35 on opposite corners to support the cards 40. In any of the configurations, an adhesive, which is discussed in more detail in conjunction with FIG. 5B, may be applied to the back of the cards 40 to provide additional support. Also, a rounded or triangular flap may cover a portion of the one or more of the edges of the card 40 to provide additional support.

In another possible slit 35 configuration for receiving and displaying cards 40 having a rectangular shape, a card 40 is inserted into a slit 35 that runs along the entire bottom edge of the card 40. This configuration would involve a multi-layered page 30 and would include a stop (such as an area in which the outer and adjacent layers are glued together) that prevents the entire card 40 from sliding into the slit 35. Such a configuration may be implemented with a similar slit 35 that runs along the top edge of the card 40. This would also involve a multi-layered page 30 and a stop. Any combination of edge slits, corner slits, or flaps is also possible.

The cards 40 need not be rectangle-shaped. For example, the cards 40 may have tabs that protrude outward from the edges that may be tucked into slits 35 to provide additional support. The tabs may be foldable so that when folded tabs are inserted into the slits 35 and pressure is applied to the top of the page 30, the tabs straighten out and engage the sides of the slits 35, preventing the cards 40 from accidentally becoming dislodged. The cards 40 may also be shaped according to the event being commemorated. For example, the cards 40 could take the shape of a heart or wedding bells for a wedding, a graduation cap for a graduation, a cross for a baptism, a circle or balloon shape for a birthday celebration, and so on. In such a case, slits 35 may be provided on the pages 30 to engage the corners of the respective shapes. Alternatively in such a case, the specially-shaped cards 40 may be secured to the pages 30 by any of the mechanisms described herein.

Pre-printed text or graphics may be transcribed on the cards 40. For example, the phrase “The Andersons: Jun. 9, 2004” may be printed on cards 40 for use in a wedding. The pre-printing text or graphics may be applied by lithographic, flexographic, gravure, embossing, or other suitable techniques. The pre-printed text or graphics may be situated such that ample space exists for guests to write personalized commemorative sentiments on the cards 40. The combination of pre-printed text and personalized commemorative sentiments may enhance the future enjoyment of the cards.

The cards preferably take the form of paper of a thickness and rigidity similar to that of a business card. However, material of any desired thickness and rigidity may be used. The personalized messages may be written on any suitable object. Scrolls, sections of canvas, or the like may be used instead of cellulose cards.

The pages 30 may also display a combination of photographs and cards 40. The photographs and the cards 40 may be the same size, allowing for a slit 35 configuration that lets viewers display photographs and cards 40 interchangeably. The photographs and the cards 40 may alternatively be different sizes. This configuration may involve two different slit 35 configurations: one for the photographs and one for the cards 40. The two slit 35 configurations may be arranged such that a particular guest's photograph may be displayed next to that guest's personalized card 40.

Vellum pages 45 are also shown. Vellum pages 45 may substantially prevent the personalized commemorative sentiments written on the cards 40 from rubbing against each other and being damaged over time. The vellum pages 45 are slightly smaller in area than the pages 30. The vellum pages 45 may optionally be the same size as the pages 30. Also, the vellum pages 45 are bound together with the pages 30 by the binder rings 20. Alternately, the vellum pages 45 may rest freely between the pages 30, allowing viewers to remove the vellum pages 45 to view the cards 40 on both open pages 30 at the same time.

An envelope or pocket may also be provided in the back of the commemorative album 10. The envelope or pocket may be affixed to or formed in the back cover 15 of the commemorative album 10. The envelope or pocket may serve as storage for other keepsakes that a user wishes not to display on the pages 30. Such keepsakes may include a wedding program or bulletin for a wedding, a graduation announcement for a graduation, and so on.

FIG. 3 shows an exemplary front cover 100 that may be disposed on the commemorative album 10 shown in FIGS. 1-2. The front cover 100 shown in FIG. 3 would be used if the commemorative event were a wedding. Several other styles of the front cover 100 may be used for a wedding guest book or wedding album. For instance, the front cover 100 may be plain white or decorated with flowers or an appropriate religious symbol. Other front cover 100 designs would be used in conjunction with other commemorative events. For example, the front cover 100 may include the transcription “Class of 2004” for a graduation album, and so on.

The front cover 100 may be made of cardboard, cardstock, wood, metal, polymer, or other suitable material, or any combination thereof. The front cover 100 may also be substantially covered by polymer, fabric, or other material designed to provide a decorative look to the front cover 100. Decorations such as bows, ribbons, lace, tassels, religious symbols, and so on may be affixed to the front cover 100, providing an event-appropriate design.

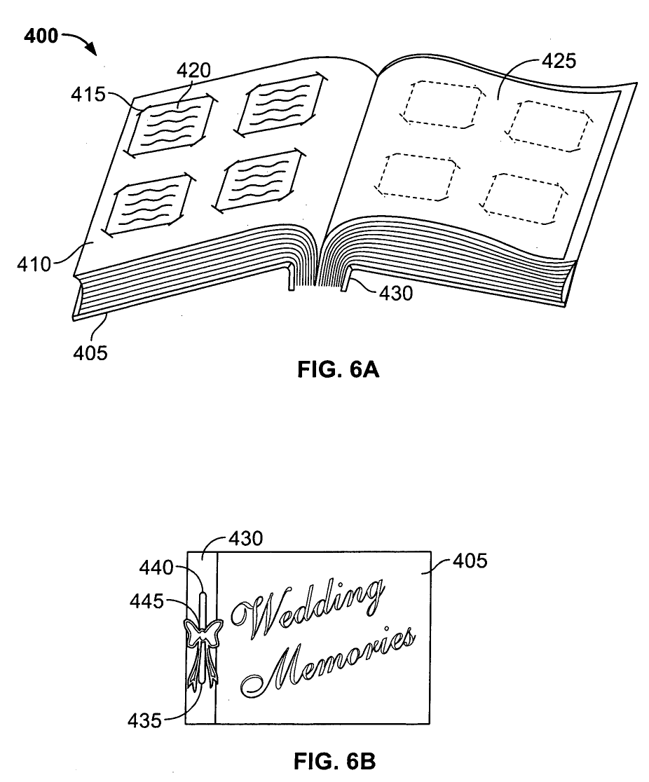

FIG. 4 shows a kit 200 for commemorating an event. The kit 200 includes a container that is made up of a cover 210 and a base portion 205. The base portion 205 has two compartments: a smaller compartment on the left and a larger compartment on the right. The smaller compartment may be further compartmentalized to provide a specific storage space for each of the contents of the kit 200. The container need not be a box. Instead, for example, the kit's components may all be shrink-wrapped together. Additionally, the container may be a box in which a hinged flap is able to tuck into the side of the box opposite the hinge and to swing open to reveal the kit's 200 contents. The container may also be covered in shrinkwrap.

The kit 200 contains several an album 215 and cards 220, both of which may include one or more of the attributes described in conjunction with FIGS. 1-3. Also, a writing utensil 225 is included. The writing utensil 225 may take any of a variety of known forms, such as a pen or pencil. The writing utensil 225 may be customized according to the event being commemorated. For example, the writing utensil 225 may have the phrase “Dennis and Susan: Jun. 1, 2004” imprinted thereon in conjunction with a wedding. Other appropriate phrases may be used for other commemorative events. Also, the writing utensil 225 may be customized to write in a color that is coordinated with the colors associated with the commemorative event, such as school colors for a graduation.

The kit 200 also includes three different types of mechanisms for holding and displaying the cards 220. First, the kit 200 includes a bag 230 of corner tabs 235. The corner tabs 235 may contain an adhesive on one side, allowing a user to affix the corner tabs 235 to pages in a desired configuration. The corner tabs 235 may also nest into slits provided in pages, providing extra support and a more decorative look. One form of corner tab 235 is shown in FIG. 5A. In FIG. 5A, the corner tabs 310 are configured on the page 300 in a manner similar to the slits 35 in FIGS. 1-2: four corner tabs 310, one for each corner of a rectangular-shaped personalized card 305. The corner tabs 310 may be configured as described above in connection with slits 35.

Referring again to FIG. 4, the second type of mechanism for holding and displaying the cards 220 included in the kit 200 is a roll of adhesive tape 240. The roll of adhesive tape 240 may dispense single-sided or double-sided adhesive tape. If double-sided, a user need only take an appropriately-sized piece of tape, affix it to the back of the card 220, and press the card 220 against the page. FIG. 5B shows a piece of double-sided tape 315 being applied to the back of a personalized card 305. The personalized card 315 will then be pressed against the page 300 in an arrangement determined by the user. Although tape 315 is shown, many different types of adhesive are possible. For example, glue, paste, adhesive putty, and so on may be used. An alternative embodiment includes pages 300 that are provided with double-sided tape 315 already adhered to the pages 300. In such a case, a removable strip may cover the double-sided tape 315. The user would remove the strip and press the card 305 against the adhesive.

Referring again to FIG. 4, the third type of mechanism for holding and displaying the cards 220 included in the kit 200 is a unassembled transparent sleeve 245. The sleeves 245 may be folded along the dashed lines to create, as shown in FIG. 5C, an assembled sleeve 320. The assembled sleeve 320 of FIG. 5C includes tabs that fold underneath to be adhered to the page 300. The personalized card 305 is then inserted from the top of the sleeve 320 for display. The opening of the sleeve 320 may alternatively be located on either side or on the bottom, provided that, if the opening is on the bottom, a stop will prevent the card 305 from slipping out the bottom of the sleeve 320 due to gravity. Examples of such stops include a lip that is integrally formed with the sleeve 320, a slit in the page 300 with a stop between layers, a flap that extends toward the opening (as shown in FIG. 5C), and so on. The assembled sleeve 320, however, need not have tabs that fold underneath to be adhered to the page 300 by an adhesive. Instead, for example, the sleeve may have tabs that tuck into corresponding slits in the page 300.

FIGS. 6A-6B shows an alternative binding configuration for a commemorative album 400. The commemorative album 400 includes covers 405, pages 410, slits 415, cards 420, and vellum pages 425, all of which may take any of the forms described in this document. However, instead of the binder-ring binding configuration of FIGS. 1-2, FIGS. 6A-6B show a binding configuration in which the pages 410 and the vellum pages 425 are pressed together between folded portions 430 of the covers 405. Two holes 435, 440 in each of the folded portions 430 of the covers 405 line up together and with two holes in each of the pages 410 and the vellum pages 425. A ribbon 445 is looped through the holes 435, 440 and tied in a bow, binding the pages 410, the vellum pages 425, and the covers 405 together. If a user wishes to add or remove a page 410, he or she need only untie the ribbon 445, lift off the appropriate number of pages 410, and add or remove the page 410. Although a ribbon 445 is shown, many other materials may be used to loop through the holes 435, 440. For instance, twine, metal, leather, or other appropriate material may be used. Other binding configurations, such as comb, coil, or wire configurations, glue bindings such as those used in hard-cover textbooks, stitch bindings are also possible.

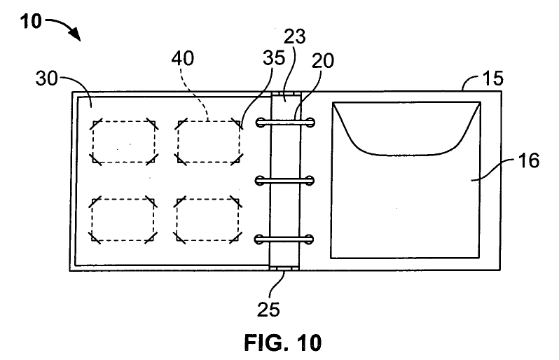

FIGS. 7A-7B illustrate a method of using a wedding guest commemoration kit to commemorate a wedding. A similar method may be employed for other types of commemorative events such as those identified above. A couple initiates the method 700 of preparing the wedding guest commemoration kit for use by obtaining a wedding guest commemoration kit (705). The couple then provides cards, a writing utensil, and the guest book to guests (710). The cards, the writing utensil, and the guest book may be presented at a centralized table, perhaps at an entryway, such that all guests are aware of them. Alternatively, the guest book and the writing utensil may be presented at a centralized table while the cards are provided by including them in each of the wedding programs or bulletins, mailing the cards to guests along with the wedding invitation, or placing a card at each place setting during a reception. As the guests arrive, and throughout the wedding ceremony and reception, guests sign the guest book (715). At the same or at a separate time, guests write a personalized commemorative sentiment on a card (720). The guests then place their completed cards in a receptacle (725). Additionally, at any point during the wedding day, or at another time such as a rehearsal dinner or bachelor or bachelorette party, guests may pose for a photograph (730). The combination of photographs of guests and cards containing personalized commemorative sentiments can provide an extra special manner of commemorating a wedding day.

When the wedding day is over and the couple has completed collecting various items to be displayed in the wedding guest book, the couple assembles the wedding guest book to commemorate the wedding. The couple may want to commemorate each guest, so the couple compares the names listed in the guest book with the guests they remember being present at the wedding or guests from whom they remember receiving gifts. From this comparison, the couple determines whether all the guests who were present at the wedding signed the guest book (735). If the couple remembers guests who did not sign the guest book, the couple writes the names of those guests in the guest book (740). If the couple took photographs of guests, the couple processes the photographs by either developing film or manipulating and printing digital photographs (745). The couple also collects the cards from the receptacle (750). There are many ways to group the cards and photographs on the pages of the guest book. The couple determines whether they wish to group the cards in a particular way (755). Some couples may simply wish to place the cards and photographs into the guest book in a random way. Other couples may wish to group the cards in a particular way, such as grouping cards written by the bride's family members, by the groom's family members, by friends, and so on. Additionally, some couples may wish to provide a photograph of a particular guest in close proximity to that guest's card. Either way, such a couple sorts the cards and photographs according to their wishes (760). Once the couple groups the cards according to their desires, the couple determines how they would like to secure the cards to the pages (765). The couple may use any of the mechanisms described above to secure the cards to the pages. The couple may also use adhesive putty, a thin polymer sheet that adheres by static, or other appropriate mechanisms or combinations thereof to secure the cards to the pages. The couple then places the cards in the guest book so that the cards are visually exposed when the book is opened to the appropriate page (770). The couple also gathers other commemorative keepsakes (775). Such keepsakes may include a wedding program or bulletin, a matchbook bearing the couple's names, and so on. The couple places the commemorative keepsakes and any cards they wish not to display in an envelope provided in the back of the guest book (780).

The kit described above may optionally include a set of instructions directing the user or suggesting that the user may perform some or all of the steps set forth above. The instructions may be printed, may take the form of a compact disc having encoded thereon a self-executing program illustrating use of the kit, or may take any other suitable form. Suitable instructions may also be coupled to each component of the kit (e.g., the cards may have coupled thereto instructions indicating that the cards should be placed next to the guest book and a receptacle for receiving the cards after the guest has written a sentiment thereon). The instructions may optionally be disposed so as to be viewable without opening the container (e.g. printed directly on the container or printed on a sheet disposed between the exterior of the container and a shrink wrap outer layer).

The commemorative album described in this document may be used to commemorate a funeral. For example, the parents or children or spouse of the deceased person may provide cards on which funeral attendees may write words of encouragement or condolence, a special memory of the deceased person, and so on. In that case, the parents or children or spouse would be able to compile the cards to commemorate the life of the deceased person or how they were able to persevere through a difficult period. Commemoration of other events is also possible.

A number of embodiments have been described. Nevertheless, it will be understood that various modifications may be made and that other embodiments are within the scope of the following claims.

1. An apparatus for displaying personalized commemorative cards comprising:
a plurality of adjacent pages bound in an album having indicia disposed thereon that are associated with a ceremonial celebration event, each page being adapted to receive a plurality of cards;
the album comprising a binding coupled to the pages, the binding maintaining the pages in adjacent relation; and
a plurality of cards disposed on each respective page, each card having a personalized handwritten sentiment disposed thereon, the handwritten personal sentiments concerning the ceremonial celebration event,
wherein the cards are disposed on each respective page such that the handwritten sentiments are substantially exposed and viewable when a respective page is unobstructed by an adjacent page.

2. The apparatus of claim 1, wherein each card comprises a plurality of corners and each page comprises a plurality of slits adapted to retain the cards by receiving at least one of the corners.

3. The apparatus of claim 1, wherein the album further comprises a cover surrounding the plurality of adjacent pages, said cover having coupled thereto a container to hold a commemorative item.

4. The apparatus of claim 3, wherein the container is an envelope or pocket.

5. The apparatus of claim 1, wherein the cards have a non-rectangular shape associated with a celebrated event.

6. The apparatus of claim 1, further comprising a plurality of photographs disposed on said pages and wherein at least one respective page has disposed thereon both a photograph and a card with a handwritten sentiment.

7. (canceled)

8. The apparatus of claim 1, wherein the personalized sentiments written on the cards are substantially entirely viewable when a respective page is unobstructed by an adjacent page.

9. A method for displaying personalized commemorative cards comprising the steps of:
providing a plurality of cards to guests at a ceremonial celebration event;
collecting the cards having handwritten personalized sentiments thereon, the handwritten personal sentiments concerning the ceremonial celebration event; and
mounting the cards to a plurality of adjacent bound pages such that each handwritten sentiment borne by a respective page is substantially visually exposed when the respective page is unobstructed by an adjacent page, the plurality of adjacent pages being bound in an album having indicia disposed thereon that are associated with the ceremonial celebration event.

10. The method of claim 9, further comprising inserting a commemorative item into a container coupled to a cover of the album.

11. The method of claim 10, wherein the container is an envelope.

12. The method of claim 9, wherein the cards have a non-rectangular shape associated with a celebrated event.

13. The method of claim 9, further comprising mounting a plurality of photographs on said pages such that at least one page has disposed thereon both a photograph and a card with a handwritten sentiment.

14. The method of claim 9, further comprising providing a plurality of sheets for the guests at the ceremonial celebration event to sign their names.

15. The method of claim 9, wherein the personalized commemorative sentiments are substantially entirely visually exposed when unobstructed by an adjacent page.

16. A kit for commemorating a ceremonial celebration event, the kit comprising:
an album comprising a plurality of pages and having indicia disposed thereon associated with a ceremonial celebration event, each page being adapted to retain and present for viewing a plurality of cards; and
a plurality of cards, wherein each card has indicia disposed thereon associated with the ceremonial celebration event and each card is adapted to have thereon a personalized commemorative sentiment handwritten concerning the ceremonial celebration event;
wherein each page is adapted to receive the cards such that the handwritten sentiments are substantially exposed and viewable when the page is unobstructed by an adjacent page.

17. The kit of claim 16, further comprising a container to hold the album, the plurality of cards, and a writing utensil.

18. The kit of claim 16, further comprising a plurality of corner tabs, each corner tab being adapted to be fastened to one of the pages.

19. The kit of claim 16, wherein the cards have a non-rectangular shape associated with the ceremonial celebration event.

20. The kit of claim 16, wherein cards include pre-printed text or graphics associated with the ceremonial celebration event.

21. The kit of claim 16, wherein the album further comprises a plurality of sheets for receiving signatures of guests at the ceremonial celebration event.

22. (canceled)

23. The kit of claim 16, wherein the pages are adapted to retain both handwritten cards and photographs.

24. The kit of claim 16, further comprising instructions to invite guests at an event to write personalized sentiments on the cards, to collect the cards, and to mount the personalized cards on the pages.

25. The kit of claim 16, further comprising a writing utensil.

26. The apparatus of claim 1, wherein the album further comprises a cover coupled to the binding, the indicia associated with a ceremonial celebration event being disposed on the cover.

27. The apparatus of claim 1, wherein the ceremonial celebration event is an event selected from the group consisting of wedding, graduation, baptism, funeral, communion, confirmation, bar mitzvah, bridal shower, and baby shower.

28. The method of claim 9, wherein the ceremonial celebration event is an event selected from the group consisting of wedding, graduation, baptism, funeral, communion, confirmation, bar mitzvah, bridal shower, and baby shower.

29. The method of claim 28, wherein when the ceremonial celebration event is a wedding, the plurality of cards are provided to guests during or before at least one of the wedding ceremony and the wedding reception.

30. The kit of claim 16, wherein the ceremonial celebration event is an event selected from the group consisting of wedding, graduation, baptism, funeral, communion, confirmation, bar mitzvah, bridal shower, and baby shower.
